(19) United States
(12) Patent Application Publication
(10) Pub. No.: US 2025/0321848 A1
(43) Pub. Date: Oct. 16, 2025

(54) INCREASING ACCURACY AND RELIABILITY OF PREDICTING A PERFORMANCE OF AN ELECTRONIC DEVICE

(71) Applicant: DISH Network L.L.C., Englewood, CO (US)

(72) Inventors: Pankaj Suresh Kumar, Denver, CO (US); Ashwini Kumar Singh, Englewood, CO (US)

(21) Appl. No.: 18/637,221

(22) Filed: Apr. 16, 2024

(51) Int. Cl. G06F 11/34

(52) U.S. Cl. CPC G06F 11/3409; G06F 11/3476

(57) ABSTRACT

The system obtains an input indicating a metric to predict, a first category associated with the metric, a second category associated with the metric, and a first and second history of the metric associated with the first and second category, respectively. The system obtains multiple assumptions and determines which of the multiple assumptions are satisfied by the first and the second history of the metric to obtain multiple satisfied assumptions. The system obtains multiple tests associated with the multiple satisfied assumptions. The system increases accuracy of predicting the metric by: performing the multiple tests on the first and the second history of the metric to obtain multiple test results; based on the multiple test results, determining a reliability of each test among the multiple tests; and based on the reliability of each test among the multiple tests and the multiple test results, predicting the metric.

### BACKGROUND

Prediction is the process of making forecasts based on past and present data. Later these can be compared (resolved) against what happens. For example, a company might estimate their revenue in the next year, and then compare it against the actual results creating a variance actual analysis. Predicting might refer to specific formal statistical methods employing time series, cross-sectional, or longitudinal data, or alternatively to less formal judgmental methods or the process of prediction and resolution itself. The application of current prediction methods can be ad hoc and unreliable due to inconsistent selection of approaches to apply to the prediction. The approaches can include average approach, naïve approach, drift method, etc.

### BRIEF DESCRIPTION OF THE DRAWINGS

Detailed descriptions of implementations of the present invention will be described and explained through the use of the accompanying drawings.

FIG. 1 shows an overview of the system to increase accuracy and reliability of predicting a performance of a device.

FIG. 2 shows the analysis performed by a system.

FIG. 3 shows various assumptions about the data test.

FIG. 4 shows multiple assumptions and the corresponding multiple tests.

FIG. 5 is a flowchart of a method to increase accuracy and reliability of making the prediction.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to increase reliability and accuracy of predicting a performance of a device. The system obtains an input indicating a metric to predict including the performance of the device, and a category A associated with the device A, and a category B associated with a device B, where the device belongs to the category A or the category B. The system obtains a history of the performance A associated with the device A and a history of the performance B associated with the device B, and multiple assumptions including: similarity of the history of the performance A to the normal distribution, independence between the performance and the category A associated with the device A, homogeneity of variance associated with the history of the performance A, randomness associated with the history of the performance A, and a monotonic relationship between the history of the performance A associated with the device A and the category A associated with the device A.

The system determines which of the multiple assumptions are satisfied by the history of the performance A and the history of the performance B to obtain multiple satisfied assumptions and obtains multiple tests associated with the multiple satisfied assumptions. The system increases reliability and accuracy of predicting the performance of the device by performing the following steps. Specifically, the system performs the multiple tests on the history of the performance A and the history of the performance B to obtain multiple test results. Based on the multiple test results, the system determines a reliability of each test among the multiple tests by, for example, determining how far a test result is from the average of results of all tests. If the test result is far, then the system determines that the test is unreliable; if close to the average, the system determines a test to be reliable. Based on the reliability of each test among the multiple tests and the multiple test results, the system predicts the performance of the device by weighing more the reliable tests in the final analysis.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Increasing Accuracy and Reliability of Predicting a Performance of a Device

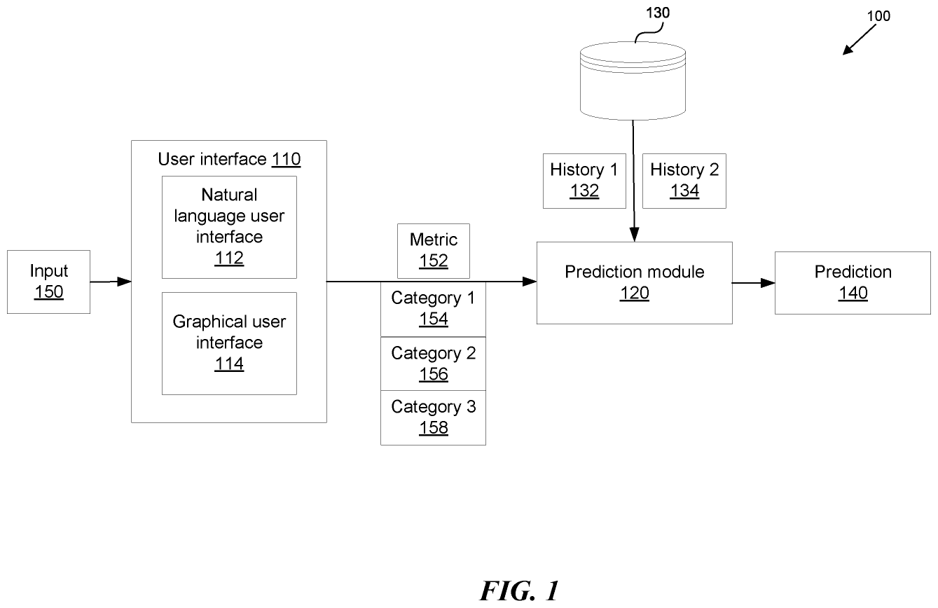

FIG. 1 shows an overview of the system to increase accuracy and reliability of predicting a performance of a device. The device can be an electronic device such as a phone, a processor, a device supporting an artificial intelligence system, etc. The system 100 includes a user interface 110, a prediction module 120, a database 130, and a prediction 140.

The user interface 110 can be a natural language user interface 112 enabling a user to provide a natural language query as input 150 or can be a graphical user interface 114 enabling a user to provide input 150 in the graphical form. The input 150 can be in the form of a query such as “which processors perform better, Nvidia RTX 4090 or Intel Arc A750,” or in the form of a hypotheses such as “Nvidia RTX 4090 performs better than Intel Arc A750.”

The system 100 can extract from the input a metric 152 and multiple categories 154, 156, and an optional third category 158 associated with the metric. For example, the metric 152 can be performance and can have categorical values such as “good,” “bad,” or “great.” The multiple categories 154, 156, 158 can specify the source associated with the performance. Categories can include types of devices, producer of the device, or, in the case of personnel, whether they came to the company through a referral or through a job board.

For example, the multiple categories 154, 156, 158 can indicate manufacture in the case of the device or a referral source in case of an employee, such as a job board or internal referral.

The prediction module 120 can perform the necessary analysis to provide a response, e.g., prediction, to the input 150. To perform the necessary analysis, the prediction module 120 can obtain from the database 130 a first history 132 of the metric associated with the first category 154, and a second history 134 of the metric associated with the second category 156. For example, the first category 154 can be Nvidia RTX 4090, the second category can be Intel Arc A750, the first history 132 of the metric can be historical processing speed of Nvidia RTX 4090 within the user's system, and the second history 134 of the metric can be historical processing speed of Intel Arc A750 within the user's system.

The prediction module 120 can analyze the first history 132, and the second history 134 by performing assumption checks and tests to determine a relationship between the metric 152 and multiple categories 154, 156, 158. After determining the relationship between the metric 152 and multiple categories 154, 156, 158, the prediction module 120 can analyze the relationship in the context of the input 150, the first history 132, and the second history 134 and can provide the prediction 140 in the form of a natural language response to the input 150.

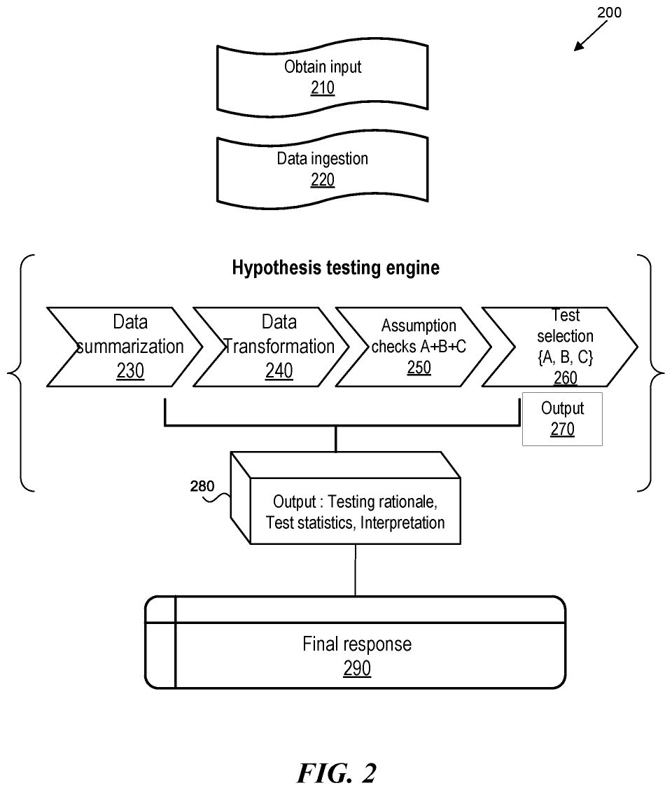

FIG. 2 shows the analysis performed by a system 200. The system 200 can be the prediction module 120 in FIG. 1. In step 210, the system 200 can obtain the input in the form of a question or a hypothesis to evaluate. In step 220, the system 200 can perform data ingestion and obtain the first history 132 in FIG. 1 and second history 134 in FIG. 1, as described in this application. In the data summarization step 230, the system 200 can determine whether the first history 132 and/or the second history 134 contain their variables that are missing values or incorrect values. If there are missing or incorrect values, the system 200 can remove or fill in missing or incorrect values based on the mean and variance of the correct values. For example, the system 200 can assign the mean value to all missing and/or incorrect values.

In the data transformation step 240, the system 200 can transform the variables included in the first history 132 and second history 134 into an appropriate format. For example, the format of a variable can be a continuous, an ordinal, or a scale variable. A continuous variable is defined as a variable that can take an uncountable set of values or infinite set of values. An ordinal variable is a categorical, statistical data type where the variables have natural, ordered categories and the distances between the categories are not known. The scale variable can be an interval or a ratio variable. A scale variable is a measurement variable, e.g., a variable that has a numeric value. Variables with numeric responses are assigned the scale variable label by default. An interval variable is one where the difference between two values is meaningful. A ratio variable has all the properties of an interval variable but also has a clear definition of 0.0. The system 200, in step 240, can transform a continuous variable into ordinal and/or scale variable, and vice versa.

In another example, the system 200 in step 240 can obtain an indication that variable values are supposed to follow a normal distribution. The indication can be stored in the database 130 in FIG. 1. After analyzing the distribution of the variable values, the system 200 can determine that the variable values do not follow the normal distribution. Upon making the determination, the system 200 in step 240 can transform the variable values to more closely follow the normal distribution.

The reason for making the transformation in step 240 is that certain tests only take a particular format of the variable, such as a continuous variable or a normal distribution variable. By transforming variables into different formats, the system 200 ensures that the variable format does not prevent a test from being applied.

In step 250, the system 200 can perform multiple assumption checks, described in this application, to determine whether particular assumptions hold true for the variables included in first history 132 and second history 134. Some of the multiple assumptions are prerequisites for a particular test to be applied in step 260. Some of the multiple assumptions may not have to be true to apply the particular test, but it may be preferred for the assumption to be true prior to applying the particular test.

In step 260, the system 200 can perform multiple tests whose assumptions have been satisfied. The multiple tests can produce an output 270 including a P value. The P value is defined as the probability, under the assumption of no effect or no difference (null hypothesis), of obtaining a result equal to or more extreme than what was actually observed. The P stands for probability and measures how likely it is that any observed difference between groups is due to chance. Being a probability, P can take any value between 0 and 1. Values close to 0 indicate that the observed difference is unlikely to be due to chance, whereas a P value close to 1 suggests no difference between the groups other than due to chance.

In step 280, the system 200 can analyze the output 270, the input 150 in FIG. 1, and/or the context to provide a response to the input 150. For example, the input 150 can contain additional information such as context. Specifically, the input 150 can state “in training artificial intelligence models, does Nvidia RTX 4090 perform better than Intel Arc A750” where “training artificial intelligence models” is the context, performance is the metric, and the categories are Nvidia RTX 4090 and Intel Arc A750. Alternatively, the system 200 can prompt the user to provide the needed context.

To analyze the output 270, which includes a P value, the system 200 can compare the P value to a predetermined threshold such as between 0.01 and 0.1. If the P value is below a predetermined threshold, the system 200 can determine that the relationship between the metric and the appropriate category, such as the first category 154 or the second category 156, is not due to chance and is a statistically significant relationship. Upon determining that the relationship is statistically significant, the system 200 can provide an output 290, e.g. prediction, indicating the statistical significance and tying the statistical significance to the metric 152, the categories 154, 156, and/or the context. The output 290 can indicate a probability estimation. For example, the system can provide the response as output 290 stating “in training artificial intelligence, Nvidia RTX 4090 performs better than Intel Arc A750.”

In addition, the system 200 can utilize artificial intelligence (AI) to interface with portions of the system 200. For example, the AI can obtain, formulate, and/or analyze the input in step 210, can summarize data in step 230, and/or transform the data in step 240, thus preparing the data for the assumption checks and test selection in steps 250 and 260. Finally, once the system performs the multiple tests and produces the output 270, the AI can perform the step 280 to analyze the output 270, the input 150 in FIG. 1, and/or the context to provide the output 290 as a final response 290.

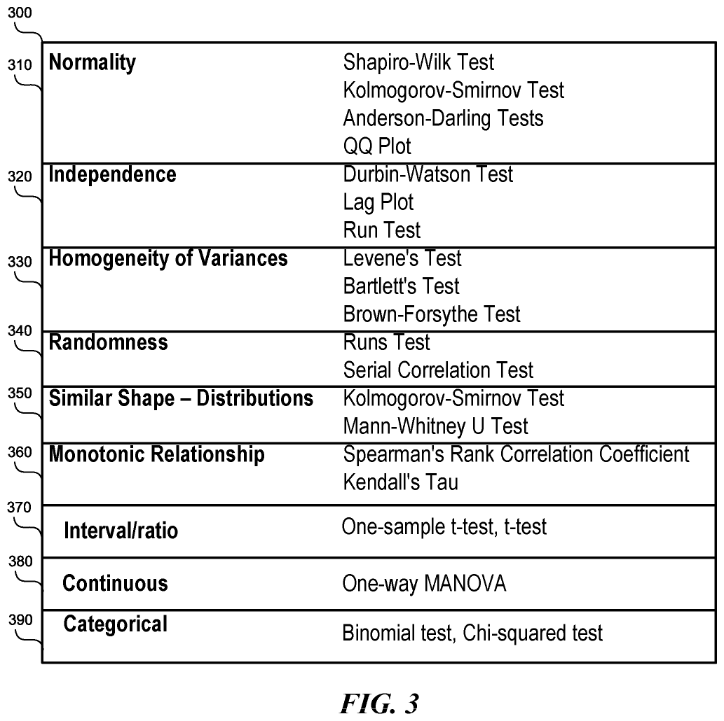

FIG. 3 shows various assumptions 300 about the data test. The data can include the first history 132 in FIG. 1 and the second history 134 in FIG. 1. The input 150 in FIG. 1 can dictate the assumptions that need to be checked. For example, if the input metric asks for correlation, then the monotonic relationship assumption 360 can be checked. Otherwise, the monotonic relationship assumption 360 is not checked.

Certain assumptions can be mutually exclusive such as assumptions 370, 380, 390. Assumption 370 can indicate that the variables in the data are interval variables or ratio variables. Assumption 380 can indicate that the variables in the data are continuous, while the assumption 390 can indicate that the data is categorical. If one of the assumptions is true such that the data is categorical, then the assumptions 380 and 370 do not need to be tested. Therefore, the system can increase speed and reduce processor cycle consumption by not performing unnecessary tests.

Normality 310 is a property of a random variable that is distributed according to the normal distribution.

Independence 320 is a fundamental notion in probability theory, as in statistics and the theory of stochastic processes. Two events are independent, statistically independent, or stochastically independent if, informally speaking, the occurrence of one does not affect the probability of occurrence of the other or, equivalently, does not affect the odds. Similarly, two random variables are independent if the realization of one does not affect the probability distribution of the other.

Homogeneity of variance 330 is an assumption underlying both t tests and F tests (analyses of variance (ANOVAs)) in which the population variances (i.e., the distribution, or “spread,” of scores around the mean) of two or more samples are considered equal.

Randomness 340 describes a phenomenon in which the outcome of a single repetition is uncertain, but there is nonetheless a regular distribution of relative frequencies in a large number of repetitions.

Similar shape distributions 350 compares the distribution of the variables in the input to a predetermined distribution, such as uniform distribution, gamma distribution, exponential distribution, beta distribution, Poisson distribution, etc.

A monotonic relationship 360 between two variables is a relationship where, as one variable goes up, the other variable also goes up, or as one variable goes up, the other variable goes down.

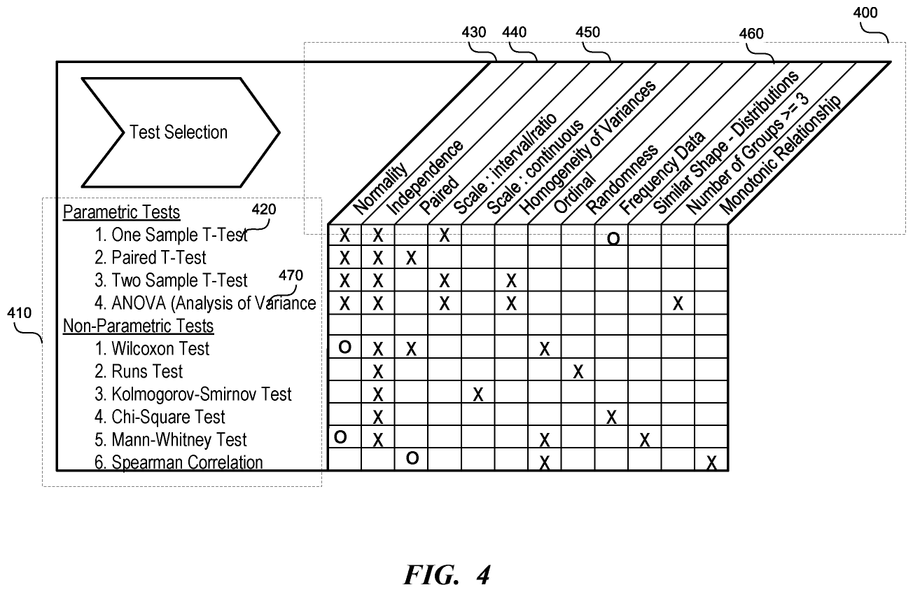

FIG. 4 shows multiple assumptions 400 and their corresponding multiple tests 410. For each test 420 among the multiple tests 410, the data must satisfy a required set of assumptions 430, 440, 450 prior to performing the test 420. The assumptions 430, 440, 450 (only three labeled for brevity) labeled with “X” in FIG. 4 indicate required assumptions. The assumptions 460 (only one labeled for brevity) labeled with “O” indicate optional assumptions, meaning that it is beneficial for data to satisfy assumptions 460 but not required.

The data, such as the first history 132 in FIG. 1 and/or second history 134 in FIG. 1, can satisfy multiple tests, such as 420, 470. If the data satisfies multiple tests 420, 470, the system performs all the satisfied tests. The system can compare the results of the multiple tests and determine the reliability of each of the results of multiple tests 420, 470. Specifically, the system can determine the outliers among the test results and determine that the test results that are outliers are not reliable. The system can assign low weights to the unreliable test results. Consequently, the unreliable test results do not influence the final output, e.g., prediction. The ability of the system to perform multiple tests, obtain tests results, and determine the reliability of each test increases the accuracy and reliability of the system compared to traditional methods because traditional methods generally perform only a single test and do not determine the reliability of a test by comparison of multiple test results.

The multiple tests 410 can be parametric or nonparametric tests. Parametric tests are suitable for continuous data, which can be measured on a numerical scale. These tests assume interval or ratio data, such as height, weight, or test scores. Parametric tests are sensitive to the scale and can make use of the precise numerical values in the analysis. Nonparametric tests can handle a wider range of data types, including ordinal and nominal data.

The one-sample t-test is a statistical hypothesis test used to determine whether an unknown population mean is different from a specific value.

The paired samples t-test compares the means of two measurements taken from the same individual, object, or related units. These “paired” measurements can represent things like a measurement taken at two different times (e.g., pre-test and post-test score with an intervention administered between the two time points).

The two-sample t-test (also known as the independent samples t-test) is a method used to test whether the unknown population means of two groups are equal or not.

ANOVA is an analysis tool used in statistics that splits an observed aggregate variability found inside a data set into two parts: systematic factors and random factors. The systematic factors have a statistical influence on the given data set, while the random factors do not. Analysts use the ANOVA test to determine the influence that independent variables have on the dependent variable in a regression study.

Among the nonparametric tests, the Kolmogorov-Smirnov test (K-S test or KS test) is a nonparametric test of the equality of continuous or discontinuous, one-dimensional probability distributions that can be used to test whether a sample came from a given reference probability distribution (one-sample K-S test), or to test whether two samples came from the same distribution (two-sample K-S test). Intuitively, the test provides a method to qualitatively answer the question “How likely is it that we would see a collection of samples like this if they were drawn from that probability distribution?” or, in the second case, “How likely is it that we would see two sets of samples like this if they were drawn from the same (but unknown) probability distribution?”.

Runs test is a nonparametric statistical test that checks a randomness hypothesis for a two-valued data sequence. More precisely, it can be used to test the hypothesis that the elements of the sequence are mutually independent.

Levene's test is an inferential statistic used to assess the equality of variances for a variable calculated for two or more groups. This test is used because some common statistical procedures assume that variances of the populations from which different samples are drawn are equal. Levene's test assesses this assumption. It tests the null hypothesis that the population variances are equal (called homogeneity of variance or homoscedasticity). If the resulting P value of Levene's test is less than some significance level (typically 0.05), the obtained differences in sample variances are unlikely to have occurred based on random sampling from a population with equal variances. Thus, the null hypothesis of equal variances is rejected and it is concluded that there is a difference between the variances in the population.

Spearman's rank correlation coefficient is a nonparametric measure of rank correlation (statistical dependence between the rankings of two variables). It assesses how well the relationship between two variables can be described using a monotonic function.

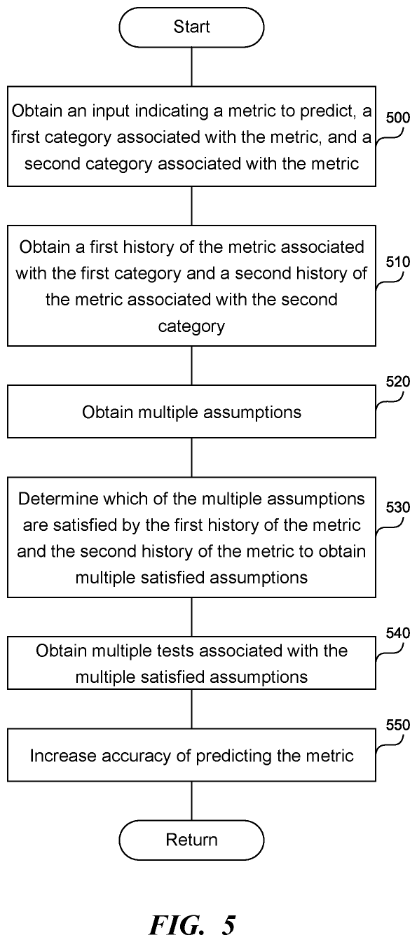

FIG. 5 is a flowchart of a method to increase accuracy and reliability of making the prediction. Prediction can relate to predicting the performance of a device or predicting a performance of a complex system. A hardware or software processor executing instructions describing this application can in step 500 obtain an input indicating a metric to predict, a first category associated with the metric, and a second category associated with the metric. The metric can be performance, while the first category and the second category can be distinct categories of devices.

In step 510, the processor can obtain a first history of the metric associated with the first category and a second history of the metric associated with the second category.

In step 520, the processor can obtain data indicating multiple assumptions where the multiple assumptions include at least one of: similarity of the first history of the metric to the normal distribution, independence between the metric and the first category, homogeneity of variance associated with the first history of the metric, randomness associated with the first history of the metric, or a monotonic relationship between the first history of the metric and the first category.

In step 530, the processor can determine which of the multiple assumptions are satisfied by the first history of the metric and the second history of the metric to obtain multiple satisfied assumptions.

In step 540, the processor can obtain multiple tests associated with the multiple satisfied assumptions.

In step 550, the processor can increase accuracy of predicting the metric by performing the following steps. The processor can perform the multiple tests on the first history of the metric and the second history of the metric to obtain multiple test results. Based on the multiple test results, the processor can determine a reliability of each test among the multiple tests. Based on the reliability of each test among the multiple tests and the multiple test results, the processor can predict the metric.

For example, to determine the reliability of each test, the processor can determine how far a test result is from the average of results of all tests. If the test result is far, such as more than two standard deviations, then the processor can determine that the test result is unreliable. If the test result is close to average, such as less than two standard deviations, the processor can determine that the test result is reliable.

The processor can obtain an indication of a first multiplicity of tests, a first multiplicity of assumptions, and a second multiplicity of assumptions, where the first multiplicity of assumptions indicates assumptions that must be satisfied, and where the second multiplicity of assumptions indicates assumptions that are preferable to satisfy. Based on the multiple satisfied assumptions and the indication of the first multiplicity of tests, the first multiplicity of assumptions, and the second multiplicity of assumptions, the processor can determine the multiple tests associated with multiple satisfied assumptions.

The processor can obtain the multiple test results by obtaining a first multiplicity of indicators of a first relationship between the first category and the first history of the metric. The first multiplicity of indicators can include P values. The processor can compare the first multiplicity of indicators to a predetermined threshold such as 0.01, 0.05, 0.1. Based on the comparison, the processor can determine that there is the relationship between the first category and the first history of the metric, meaning that the relationship between the first category in the first history of the metric is not random. Upon determining that there is the relationship, the processor can predict the metric. For example, if the original query asks the processor to predict a performance of a device, the processor can determine a category associated with the device by determining whether the device belongs in the first category or the second category. Based on the category associated with the device, the processor can predict the performance of the device.

The processor can obtain a natural language input, such as can be in the form of which smartphone is best to buy. The processor can extract from the natural language input the metric to predict, the first category, and the second category. In the above example, to determine the metric and the first and second categories, the processor can obtain benchmarking tests run on smartphones. The metric can be the performance of the benchmarking test, and the categories can be the various tests run on the smartphones. Based on the benchmarking test, the processor can determine an answer to the natural language input.

The processor can provide a graphical user interface enabling the user to specify the metric, the first category and the second category. The processor can obtain through the graphical user interface an indication of the metric, an indication of the first category, and the indication of the second category.

The processor can increase a speed of computation by performing the following steps. The processor can obtain an indication of the multiple assumptions that are mutually exclusive, where the indication includes a first assumption and a second assumption, such as variable type is interval/ratio, continuous, or ordinal. The processor can determine that the first assumption among the multiple assumptions is satisfied. Upon determining that the first assumption is satisfied, the processor can increase the speed of computation by avoiding determining whether the second assumption is satisfied.

The processor can provide the multiple test results and the input to an artificial intelligence. The processor can obtain an analysis of the multiple test results from the artificial intelligence. The processor can provide the analysis of the multiple test results.

### Computer System

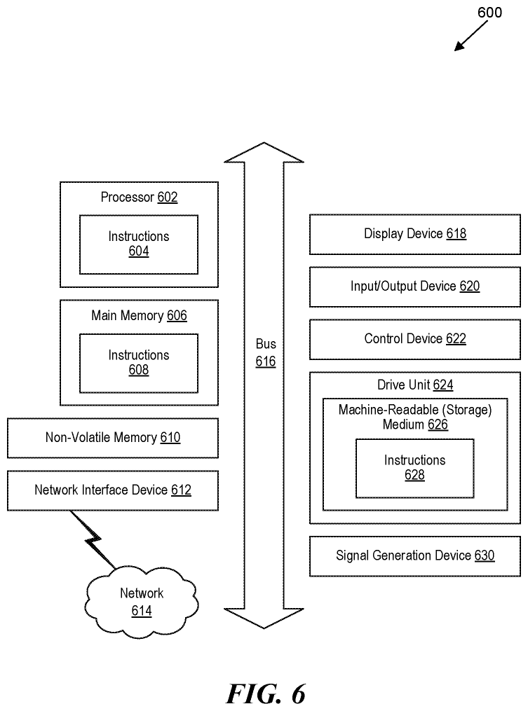

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), augmented reality/virtual reality system (e.g., head-mounted display), or any electronic device capable of executing a set of instructions that specify action(s) to be taken by the computer system 600. In some implementations, the computer system 600 can be an embedded computer system, a system-on-chip (SOC), a single-board computer (SBC) system, or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable (storage) medium 626) can be local, remote, or distributed. Although shown as a single medium, the machine-readable (storage) medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable (storage) medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions to increase accuracy of predicting a performance of a device recorded thereon, wherein the instructions, when executed by at least one data processor of a system, cause the system to:
obtain an input indicating a metric to predict including the performance of the device, and a first category associated with a first device, and a second category associated with a second device,
wherein the device belongs to the first category or the second category;
obtain a first history of the performance associated with the first device and a second history of the performance associated with the second device;
obtain data indicating multiple assumptions wherein the multiple assumptions include at least three of: similarity of the first history of the performance to normal distribution, independence between the performance and the first category associated with the first device, homogeneity of variance associated with the first history of the performance, randomness associated with the first history of the performance, and a monotonic relationship between the first history of the performance associated with the first device and the first category associated with the first device;
determine which of the multiple assumptions are satisfied by the first history of the performance and the second history of the performance to obtain multiple satisfied assumptions;
obtain multiple tests associated with the multiple satisfied assumptions; and
increase accuracy of predicting the performance of the device by:
performing the multiple tests on the first history of the performance and the second history of the performance to obtain multiple test results;
based on the multiple test results, determining a reliability of each test among the multiple tests; and
based on the reliability of each test among the multiple tests and the multiple test results, predicting the performance of the device.

2. The non-transitory, computer-readable storage medium of claim 1, wherein the instructions to obtain the multiple tests associated with the multiple satisfied assumptions comprise instructions to:
obtain an indication of a first multiplicity of tests, a first multiplicity of assumptions, and a second multiplicity of assumptions,
wherein the first multiplicity of assumptions indicates assumptions that must be satisfied,
wherein the second multiplicity of assumptions indicates assumptions that are preferable to satisfy; and
based on the multiple satisfied assumptions and the indication of the first multiplicity of tests, the first multiplicity of assumptions, and the second multiplicity of assumptions, determine the multiple tests associated with the multiple satisfied assumptions.

3. The non-transitory, computer-readable storage medium of claim 1, comprising instructions to:
obtain the multiple test results by obtaining a first multiplicity of indicators of a first relationship between the first category associated with the first device and the first history of the performance;
compare the first multiplicity of indicators to a predetermined threshold;
based on the comparison, determine that there is a relationship between the first category associated with the first device and the first history of the performance;
upon determining that there is the relationship, determine a category associated with the device by determining whether the device belongs in the first category or the second category; and
based on the category associated with the device, predict the performance associated with the device.

4. The non-transitory, computer-readable storage medium of claim 1, wherein the instructions to obtain the input comprise instructions to:
obtain a natural language input; and
extract from the natural language input the metric to predict, the first category associated with the first device, and the second category.

5. The non-transitory, computer-readable storage medium of claim 1, wherein the instructions to obtain the input comprise instructions to:
provide a graphical user interface enabling a user to specify the metric, the first category, and the second category; and
obtain through the graphical user interface an indication of the metric, an indication of the first category, and the indication of the second category.

6. The non-transitory, computer-readable storage medium of claim 1, wherein the instructions to determine which of the multiple assumptions are satisfied comprise instructions to:
increase a speed of computation by:
obtaining an indication of the multiple assumptions that are mutually exclusive, wherein the indication includes a first assumption and a second assumption;
determining that the first assumption among the multiple assumptions is satisfied; and
upon determining that the first assumption is satisfied, increasing the speed of computation by avoiding determining whether the second assumption is satisfied.

7. The non-transitory, computer-readable storage medium of claim 1, comprising instructions to:
provide the multiple test results and the input to an artificial intelligence;
obtain an analysis of the multiple test results from the artificial intelligence; and
provide the analysis of the multiple test results.

8. A method comprising:
obtaining an input indicating a metric to predict, a first category associated with the metric, and a second category associated with the metric;
obtaining a first history of the metric associated with the first category and a second history of the metric associated with the second category;
obtaining data indicating multiple assumptions wherein the multiple assumptions include at least one of: similarity of the first history of the metric to normal distribution, independence between the metric and the first category, homogeneity of variance associated with the first history of the metric, randomness associated with the first history of the metric, or a monotonic relationship between the first history of the metric and the first category;
determining which of the multiple assumptions are satisfied by the first history of the metric and the second history of the metric to obtain multiple satisfied assumptions;
obtaining multiple tests associated with the multiple satisfied assumptions; and
increasing accuracy of predicting the metric by:
performing the multiple tests on the first history of the metric and the second history of the metric to obtain multiple test results;
based on the multiple test results, determining a reliability of each test among the multiple tests; and
based on the reliability of each test among the multiple tests and the multiple test results, predicting the metric.

9. The method of claim 8, wherein obtaining the multiple tests associated with the multiple satisfied assumptions comprises:
obtaining an indication of a first multiplicity of tests, a first multiplicity of assumptions, and a second multiplicity of assumptions,
wherein the first multiplicity of assumptions indicates assumptions that must be satisfied,
wherein the second multiplicity of assumptions indicates assumptions that are preferable to satisfy; and
based on the multiple satisfied assumptions and the indication of the first multiplicity of tests, the first multiplicity of assumptions, and the second multiplicity of assumptions, determining the multiple tests associated with the multiple satisfied assumptions.

10. The method of claim 8, comprising:
obtaining the multiple test results by obtaining a first multiplicity of indicators of a first relationship between the first category and the first history of the metric;
comparing the first multiplicity of indicators to a predetermined threshold;
based on the comparison, determining that there is a relationship between the first category and the first history of the metric; and
upon determining that there is the relationship, predicting the metric.

11. The method of claim 8, wherein obtaining the input comprises:
obtaining a natural language input; and
extracting from the natural language input the metric to predict, the first category, and the second category.

12. The method of claim 8, wherein obtaining the input comprises:
providing a graphical user interface enabling a user to specify the metric, the first category, and the second category; and
obtaining through the graphical user interface an indication of the metric, an indication of the first category, and the indication of the second category.

13. The method of claim 8, wherein determining which of the multiple assumptions are satisfied comprises:
increasing a speed of computation by:
obtaining an indication of the multiple assumptions that are mutually exclusive, wherein the indication includes a first assumption and a second assumption;
determining that the first assumption among the multiple assumptions is satisfied; and
upon determining that the first assumption is satisfied, increasing the speed of computation by avoiding determining whether the second assumption is satisfied.

14. A system comprising:
at least one hardware processor; and
at least one non-transitory memory storing instructions, which, when executed by the at least one hardware processor, cause the system to:
obtain an input indicating a metric to predict, a first category associated with the metric, and a second category associated with the metric;
obtain a first history of the metric associated with the first category and a second history of the metric associated with the second category;
obtain data indicating multiple assumptions wherein the multiple assumptions include at least one of: similarity of the first history of the metric to normal distribution, independence between the metric and the first category, homogeneity of variance associated with the first history of the metric, randomness associated with the first history of the metric, or a monotonic relationship between the first history of the metric and the first category;
determine which of the multiple assumptions are satisfied by the first history of the metric and the second history of the metric to obtain multiple satisfied assumptions;
obtain multiple tests associated with the multiple satisfied assumptions; and
increase accuracy of predicting the metric by:
performing the multiple tests on the first history of the metric and the second history of the metric to obtain multiple test results;
based on the multiple test results, determining a reliability of each test among the multiple tests; and
based on the reliability of each test among the multiple tests and the multiple test results, predicting the metric.

15. The system of claim 14, wherein the instructions to obtain the multiple tests associated with the multiple satisfied assumptions comprise instructions to:
obtain an indication of a first multiplicity of tests, a first multiplicity of assumptions, and a second multiplicity of assumptions,
wherein the first multiplicity of assumptions indicates assumptions that must be satisfied,
wherein the second multiplicity of assumptions indicates assumptions that are preferable to satisfy; and
based on the multiple satisfied assumptions and the indication of the first multiplicity of tests, the first multiplicity of assumptions, and the second multiplicity of assumptions, determine the multiple tests associated with the multiple satisfied assumptions.

16. The system of claim 14, comprising instructions to:
obtain the multiple test results by obtaining a first multiplicity of indicators of a first relationship between the first category and the first history of the metric;
compare the first multiplicity of indicators to a predetermined threshold;
based on the comparison, determine that there is a relationship between the first category and the first history of the metric; and
upon determining that there is the relationship, predict the metric.

17. The system of claim 14, wherein the instructions to obtain the input comprise instructions to:
obtain a natural language input; and
extract from the natural language input the metric to predict, the first category, and the second category.

18. The system of claim 14, wherein the instructions to obtain the input comprise instructions to:
provide a graphical user interface enabling a user to specify the metric, the first category and the second category; and
obtain through the graphical user interface an indication of the metric, an indication of the first category, and the indication of the second category.

19. The system of claim 14, wherein instructions to determine which of the multiple assumptions are satisfied comprise instructions to:
increase a speed of computation by:
obtaining an indication of the multiple assumptions that are mutually exclusive, wherein the indication includes a first assumption and a second assumption;
determining that the first assumption among the multiple assumptions is satisfied; and
upon determining that the first assumption is satisfied, increasing the speed of computation by avoiding determining whether the second assumption is satisfied.

20. The system of claim 14, comprising instructions to:
provide the multiple test results and the input to an artificial intelligence;
obtain an analysis of the multiple test results from the artificial intelligence; and
provide the analysis of the multiple test results.
